(19) United States
(12) Patent Application Publication
(10) Pub. No.: US 2007/0156549 A1
(43) Pub. Date: Jul. 5, 2007

(54) System and method for managing negotiable items

(76) Inventor: Tommy Tran, Canoga Park, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/322,153

(22) Filed: Dec. 29, 2005

(51) Int. Cl. G06Q 40/00

(52) U.S. Cl. 705/35

(57) ABSTRACT

A system and method for managing an inventory of negotiable instruments. The system comprises an enterprise server, a data network, a database, and a network interface. The data network coupled the enterprise server to the database. The network interface couples a branch or other location to the enterprise server via the data network. The enterprise server is configured with logic that when executed generates user interfaces that enable the creation and operational use of one or more drawers for holding negotiable items. The one or more drawers are shared among one or more co-located customer service terminals.

Many banks or financial institutions provide multiple negotiable products to their customers. For example, it is common to be able to purchase gift checks, money orders, traveler's checks, as well as official checks or bank drafts drawn against certified assets of the issuing bank or financial institution. Thus, it would be desirable to provide an inventory maintenance system that addresses the needs of multiple users who need to generate, control and distribute these types of assets to consumers.

### SUMMARY

An embodiment of a system for managing negotiable items across an enterprise comprises an enterprise server, a data network, a database and a network interface. The data network couples the database to the enterprise server. The network interface couples one or more co-located customer service terminals to the enterprise server. The enterprise server contains logic that when executed creates and maintains a menu driven user interface that exposes one or more drawers for holding a negotiable item that is shareable across the one or more co-located customer service terminals.

An embodiment of a method for managing an inventory of negotiable instruments comprises collecting information associated with a select location, providing a first interface configured to enable an operator with supervisor privileges to allocate one or more negotiable items to one or more drawers associated with the select location, providing a second interface configured to enable an operator to edit a field associated with each negotiable item type, providing a third interface configured to enable a customer service representative to allocate one or more negotiable items to the one or more drawers and communicating with a customer service application that enables one or more customer service representatives to conduct transactions via the one or more drawers.

### BRIEF DESCRIPTION OF THE FIGURES

The systems and methods for managing an inventory of negotiable instruments can be better understood with reference to the following figures. The components within the figures are not necessarily to scale, emphasis instead being placed upon clearly illustrating the principles behind the systems and methods. Moreover, in the figures, like reference numerals designate corresponding parts throughout the different views.

FIG. 1 is a schematic diagram illustrating an embodiment of a system of network coupled computing devices.

FIG. 2 is a schematic diagram illustrating an embodiment of the enterprise server of FIG. 1.

FIG. 3 is a schematic diagram illustrating an embodiment of a drawer maintenance interface.

FIG. 4 is a schematic diagram illustrating an embodiment of an article maintenance interface.

FIG. 5 is a schematic diagram illustrating an embodiment of a stock allocation interface.

FIG. 6 is a schematic diagram illustrating an embodiment of a customer transaction interface.

FIG. 7 is a schematic diagram illustrating an embodiment of a drawer balance interface.

FIG. 8 is a schematic diagram illustrating an embodiment of a negotiable items adjustment interface.

FIG. 9 is a schematic diagram illustrating an embodiment of a report interface.

FIG. 10 is a flow diagram illustrating an embodiment of a method for managing an inventory of negotiable instruments.

### DETAILED DESCRIPTION

An enterprise server and database are used to generate multiple interfaces for creating and managing negotiable instruments in a point-of-service environment such as a branch office of a bank or other financial institution. The enterprise server includes logic configured to generate interfaces for allocating and ordering stock, controlling inventory, maintaining articles, issuers and drawers, managing customer service transactions, viewing negotiable item details, checking for a balanced condition, and adjusting a general ledger.

Stock allocation is the process of adding new negotiable items to the negotiable item inventory as well as removing existing items from the inventory.

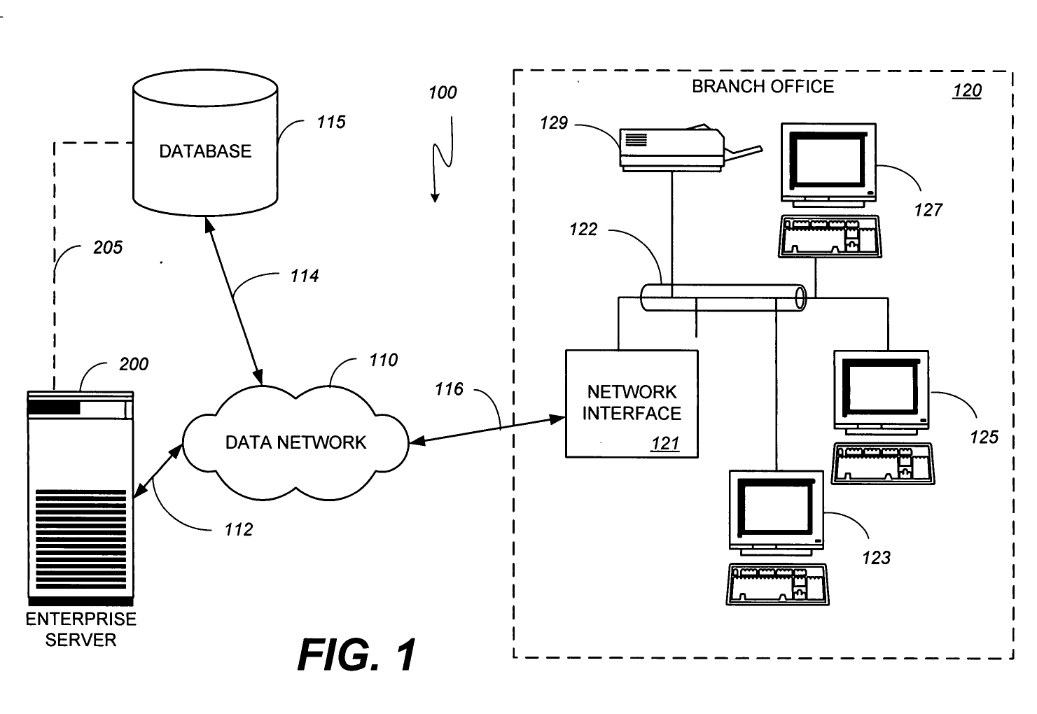

After negotiable items have been allocated to the inventory, customer service representatives can order desired counts of one or more negotiable articles. An article defines the issuer of the item and a denomination of each occurrence of the item (i.e., an American Express® traveler's check in the amount of $50 U.S. dollars. American Express® is the registered trademark of the American Express Company of New York, N.Y., U.S.A.). Article maintenance includes setting permissions for the buying and selling of particular negotiable item or items by one or more groups of customer service representatives and or setting buying and selling rates (i.e., premiums or discount rates to be applied to transactions. Drawer maintenance includes views and mechanisms for managing negotiable items across groups of customer service representatives at the branch level. Having described in general the system and method for managing an inventory of negotiable instruments, various embodiments will be described with respect to FIGS. 1-10 below.

FIG. 1 is a schematic diagram illustrating an embodiment of a system 100 of network coupled computing devices. System 100 includes an enterprise server 200 coupled to database 115 and various devices within a branch office 120 via data network 110. Enterprise server 200 is coupled to data network via link 112. Database 115 is coupled to data network 110 via link 114. Branch office 120 is coupled to data network 110 via link 116. Enterprise server 200 can also be directly coupled to database via optional link 205.

Enterprise server 200 is one or more computing devices that supports multiple communication sessions with one or more branch offices such as branch office 120. Enterprise server 200 works in conjunction with data stored in database 115 to enable multiple applications within computing devices located within branch office 120. In one embodiment, enterprise server 200 is built on a commercial off-the-shelf (COTS) Java 2 enterprise edition (J2EE) application server. Enterprise server 200 provides common processes and services, file management and data stores. Enterprise server 200 may be implemented using various technologies, including but not limited to, XML, SOAP, WSDL, UDDI, etc. Logic stored in various programs within enterprise server 200 includes a plurality of rules and operational parameters for supporting runtime core functionality.

Branch office 120 includes multiple computing devices such as workstation 123, workstation 125 and workstation 127 each interconnected via local area network 122. Local area network 122 is coupled to data network 110 via network interface 121, which exposes each of workstation 123, workstation 125 and workstation 127 to the computing resources resident within enterprise server 200 and the data stored in database 115. Workstation 123, workstation 125 and perhaps others (not shown) can be used by customer service representatives to perform and manage customer transactions at the branch office 120. Workstation 127 is associated with a branch manager or other supervisor that performs back-office functions (i.e., functions not related to directly serving customers at branch office 120. Workstation 123, workstation 125 and workstation 127, among others use printer 129 to prepare hard copy reports, such as but not limited to negotiable items inventory reports and receipts for customer transactions.

Workstation 123, workstation 125 and workstation 127, among others will be configured with one or more local programs or modules that support customer transactions when connectivity with enterprise server 200 has been interrupted. In alternative embodiments, branch office 120 may include one or more computing devices and data storage devices that support local operation absent network connectivity with enterprise server 200.

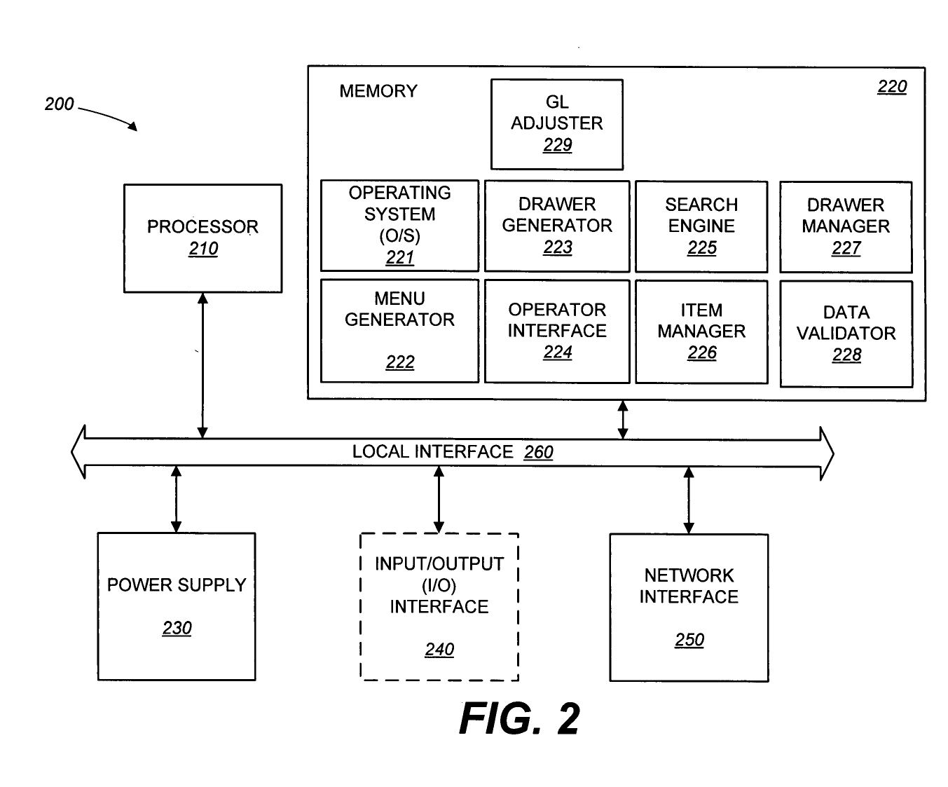

FIG. 2 is a schematic diagram illustrating an embodiment of the enterprise server 200 of FIG. 1. Generally, in terms of hardware architecture, as shown in FIG. 2, enterprise server 200 includes processor 210, memory 220, power supply 230, input/output interface 240 and network interface 250 that are communicatively coupled via a local interface 260. The local interface 260 can be, for example but not limited to, one or more buses or other wired or wireless connections, as is known in the art. The local interface 260 may have additional elements, which are omitted for simplicity, such as controllers, buffers (caches), drivers, repeaters, and receivers, to enable communications. Further, the local interface 260 may include address, control, and/or data connections to enable appropriate communications among the aforementioned components.

Processor 210 is a hardware device for executing software, particularly that stored in memory 220. The processor 210 can be any custom made or commercially available processor, a central processing unit (CPU), an auxiliary processor among several processors associated with the enterprise server 200, a semiconductor based microprocessor (in the form of a microchip or chip set), or generally any device for executing software instructions.

The memory 220 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disc read-only memory (CDROM), etc.). Moreover, the memory 220 may incorporate electronic, magnetic, optical, and/or other types of storage media. Note that the memory 220 can have a distributed architecture, where various components are situated remote from one another, but can be accessed by the processor 210.

The software in memory 220 may include one or more separate programs, each of which comprises an ordered listing of executable instructions for implementing logical functions. In the example of FIG. 2, the software in the memory 220 includes operating system 221, menu generator 222, drawer generator 223, operator interface 224, search engine 225, item manager 226, drawer manager 227, data validator 228 and general ledger (GL) adjuster 229. The operating system 222 essentially controls the execution of other computer programs, such as menu generator 222, drawer generator 223, operator interface 224, search engine 225, item manager 226, drawer manager 227, data validator 228 and general ledger (GL) adjuster 229 and provides scheduling, input-output control, file and data management, memory management, and communication control and related services.

Each of menu generator 222, drawer generator 223, operator interface 224, search engine 225, item manager 226, drawer manager 227, data validator 228 and general ledger (GL) adjuster 229 is a source program, executable program (object code), script, or any other entity comprising a set of instructions to be performed. When implemented as a source program, each program is translated via a compiler, assembler, interpreter, or the like, which may or may not be included within the memory 220, so as to operate properly in connection with the O/S 221. Furthermore, each of menu generator 222, drawer generator 223, operator interface 224, search engine 225, item manager 226, drawer manager 227, data validator 228 and general ledger (GL) adjuster 229 can be written in one or more object oriented programming languages, which have classes of data and methods, or procedure programming languages, which have routines, subroutines, and/or functions.

Menu generator 222 includes logic configured to provide one or more options in response to one or more inputs in accordance with a present context within a program flow and the authorization privileges of the operator. Drawer generator 223 includes logic configured to enable an operator with supervisor privileges to create a drawer or placeholder for holding an managing a set of one or more negotiable items. Operator interface 224 is configured to enable an operator to interact with each of the various menus and GUIs. Search engine 225 is configured to enable each of the other programs to extract data from database 115. Item manager 226 is configured to enable an operator to adjust buying and selling privileges for particular types of negotiable items on a group basis as well as adjust buying and selling rates for each article associated with a drawer.

Data validator 228 is configured to apply one or more data collection rules on an item basis. Depending on the item type, data validator 228 may apply one or more rules or conditional checks against entered data, for example required, date, integer, string length, range, regular expression and precision. The required validator ensures that an associated field was filled in by an operator of the interface. The date validator checks the validity of the date and is supplemented with a regular expression format check when a strict date entry is required. The integer validator checks to make sure data is entered in the field is an integer. The string length validator ensures that text entry falls within a min./max. character length range. The range validator checks to make sure numbers fall within a designated range. The regular expression validator compares entered text against a designated regular expression. The precision validator ensures the precision of a number falls within the bounds of a specified precision. Other validators may also be applied as may be desired. Any particular user-interface item can have none to many validators applied. Once validation has completed, any errors are collected in a list using default error templates or by using custom error messages provided in database 115 or within native code at each of the workstations.

GL adjuster 229 is configured to add or remove one or more identified negotiable items from an identified drawer. GL adjuster 229 functions in conjunction with operator interface 224, drawer manager 227 and search engine 225 to enable an operator of one or more the branch office workstations to correct a drawer inventory.

Power supply 230 provides power to each of the processor 210, memory 220, I/O interface 240, network interface 250 and local interface 260 in a manner understood by one of ordinary skill in the art.

I/O interface 240 is a hardware device for communicatively coupling optional local input devices, for example but not limited to, a keyboard, mouse, scanner, microphone, etc. Furthermore, I/O interface 240 communicatively couples local output devices, for example but not limited to, a printer, display, etc. These local I/O devices may be provided to configure and maintain enterprise server 200 as desired.

Network interface 250 is a hardware device for communicatively coupling enterprise server 200 to other devices via various wired and wireless networks. In this regard, network interface 250 may include devices that communicate both inputs and outputs, for instance but not limited to, a modulator/demodulator (modem; for accessing another device, system, or network), a radio frequency (RF) or other transceiver, a telephonic interface, a bridge, a router, etc.

When enterprise server 200 is in operation, the processor 210 is configured to execute software stored within the memory 220, to communicate data to and from the memory 220, and to generally control operations of the enterprise server 200 pursuant to the software. The menu generator 222, drawer generator 223, operator interface 224, search engine 225, item manager 226, drawer manager 227, data validator 228, GL adjuster 229 and the O/S 221, in whole or in part, but typically the latter, are read by the processor 210, perhaps buffered within the processor 210, and then executed.

When one or more of the menu generator 222, drawer generator 223, operator interface 224, search engine 225, item manager 226, drawer manager 227, data validator 228 and GL adjuster are implemented in software, as is shown in FIG. 2, it should be noted that the associated logic can be stored on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM), an electrically erasable programmable read-only memory (EEPROM), or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more of the menu generator 222, drawer generator 223, operator interface 224, search engine 225, item manager 226, drawer manager 227, data validator 228, GL adjuster 229 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field programmable gate array (FPGA), etc.

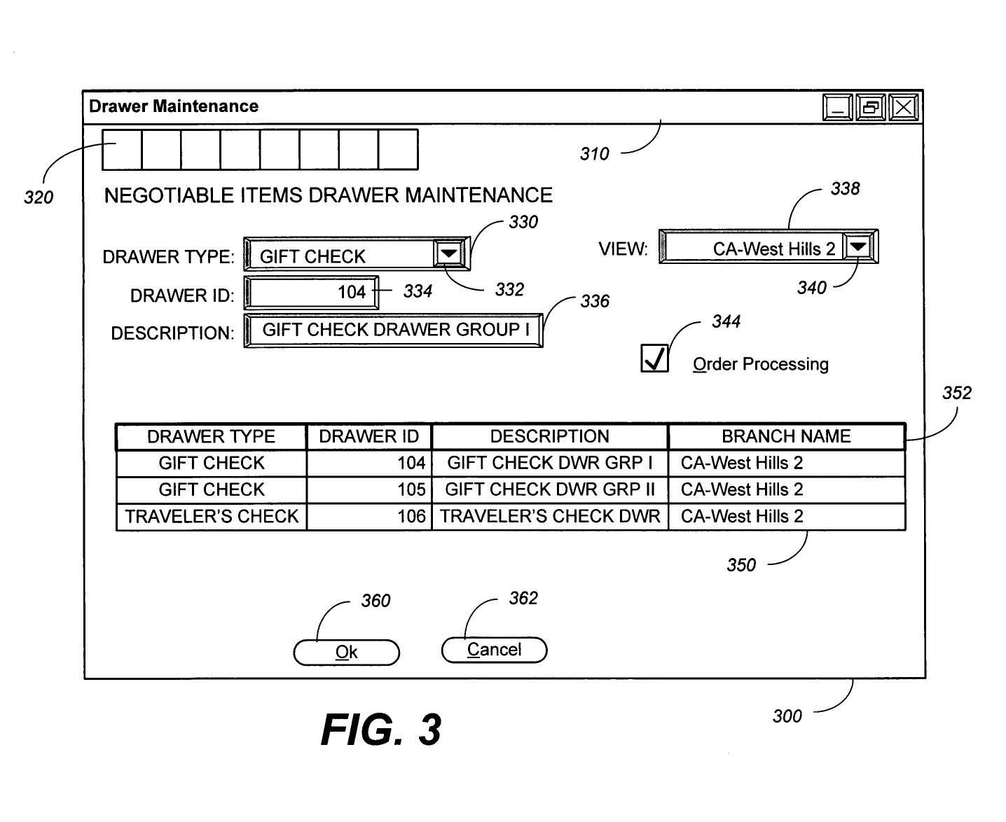

FIG. 3 is a schematic diagram illustrating an embodiment of a drawer maintenance interface 300. In the illustrated embodiment, drawer maintenance interface 300 is a GUI arranged to enable a supervisor or other authorized operator to quickly generate a new drawer or locate and access the present status of a select drawer in the enterprise database. Drawers are placeholders for negotiable items and are shareable between customer service representatives. After a drawer has been generated, stock for negotiable items can be allocated and assigned to the drawer. The list of drawer types is configurable. Drawer maintenance interface 300 includes title bar 310, labeled “Drawer Maintenance” that contains window controls to minimize, restore, or close the interface. Drawer maintenance interface 300 further includes control bar 320, which comprises a number of icon labeled pushbuttons that direct a common function to be applied to the drawer maintenance interface 300.

Drawer maintenance interface 300 further includes drawer type field 330, drawer identifier field 334, description field 336 and view field 338. Pushbutton 332 enables a drop-down menu of additional selectable drawer types. Pushbutton 340 enables a drop-down menu of additional selectable branches within the enterprise.

Drawer type 330 includes information regarding a select placeholder. Drawer identification field 334 includes a name or other code associated with the select drawer or placeholder. View field 338 includes the name of a select branch office.

Drawer maintenance interface 300 also includes checkbox 334, which when activated enables customer service representatives to place orders for additional negotiable items to be added to a select drawer. Drawer maintenance interface 300 also presents data table 350, which includes title row 352. In the illustrated embodiment, title row 352 includes four columns labeled “drawer type,” “drawer id,” “description” and “branch name.” Data table 350 further includes information stored within the enterprise database 115 in accordance with the displayed criteria. Moreover, drawer maintenance interface 300 includes pushbutton 360, which when activated indicates that the operator acknowledges that the select drawer is enabled or disabled for order processing and pushbutton 362, which cancels or otherwise closes drawer maintenance interface 300.

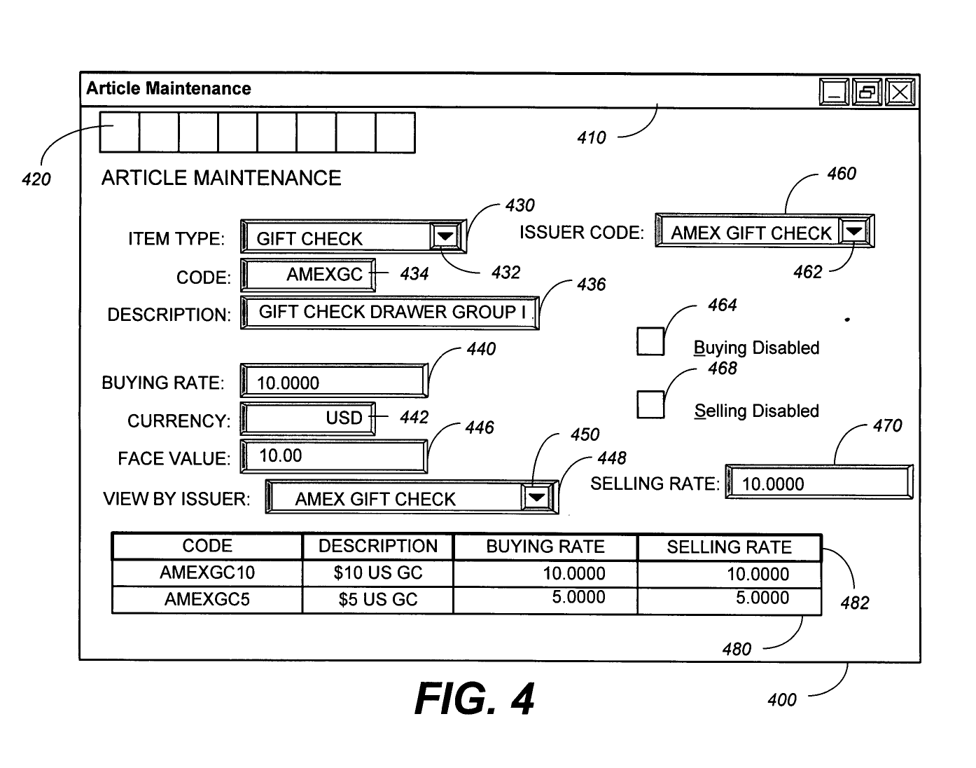

FIG. 4 is a schematic diagram illustrating an embodiment of an article maintenance interface 400. In the illustrated embodiment, article maintenance interface 400 is a GUI arranged to enable a supervisor or other authorized operator to quickly generate and maintain articles for negotiable items. Each negotiable item type is a separate and distinct article. By way of example a $20 American Express® gift check is an article. A denomination is not associated with official bank checks and money orders, as denominations for these negotiable items vary with each transaction.

Article maintenance interface 400 includes title bar 410, labeled “Article Maintenance” that contains window controls to minimize, restore, or close the interface. Article maintenance interface 400 further includes control bar 420, which comprises a number of icon labeled pushbuttons that direct a common function to be applied to the article maintenance interface 400.

Article maintenance interface 400 further includes item type field 430, code field 434, description field 436 and issuer field 460 as well as buying rate field 440, currency field 442, face value field 446, view-by-issuer field 448 and selling rate field 470. Pushbutton 432 enables a drop-down menu of additional selectable negotiable item types. Pushbutton 462 enables a drop-down menu of additional selectable issuer codes. Pushbutton 450 enables a drop-down menu of additional selectable issuer items. Item type field 430 includes information regarding a select article. Code field 434 includes a code associated with the select article. Description field 436 includes information identifying a drawer group. Issuer field 460 includes information responsive to an issuer's code for the select article. Buying rate field 440 includes information responsive to a rate to be applied to purchases of the select article. Currency field 442 includes information identifying the native currency associated with the article. Face value filed 446 includes a denomination that is printed or otherwise applied to each occurrence of the select article. Selling rate field 470 includes information responsive to a rate to be applied to sales that include the select article.

Article maintenance interface 400 also includes checkbox 464, which when activated enables customer service representatives to purchase additional negotiable items and checkbox 468, which when activated enables customer service representatives to sell negotiable items to customers. Article maintenance interface 400 also presents data table 480, which includes title row 482. In the illustrated embodiment, title row 482 includes four columns labeled “code,” “description,” “buying rate” and “selling rate.” Data table 480 further includes information stored within the enterprise database 115 in accordance with the displayed criteria. Moreover, article maintenance interface 400 may include additional pushbuttons (not shown) such as a first pushbutton that when activated indicates that the operator acknowledges the select information for future transaction processing and a second pushbutton that cancels or otherwise closes article maintenance interface 400.

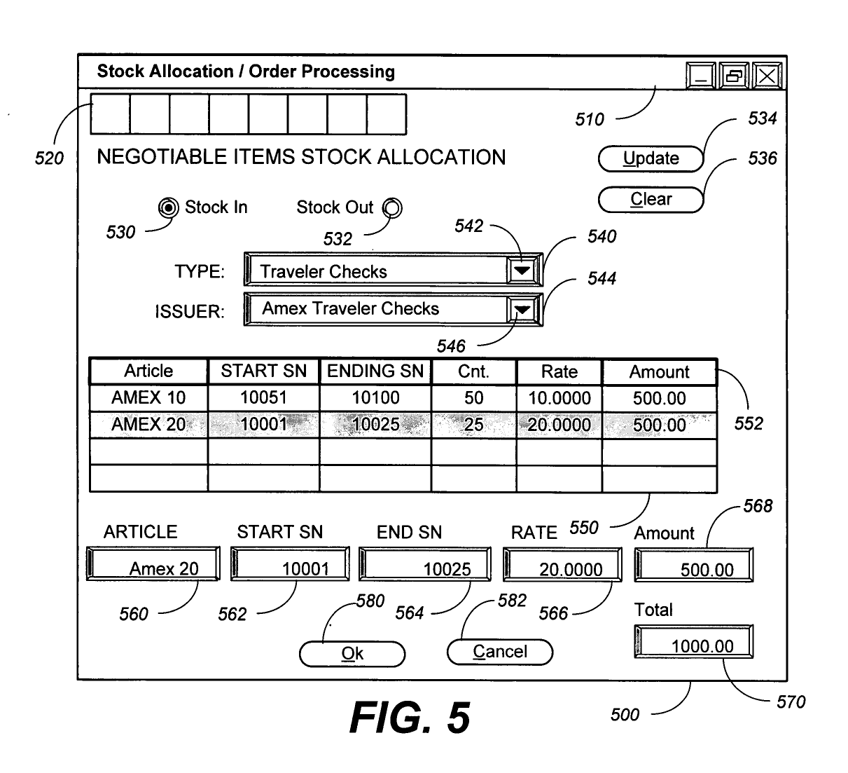

FIG. 5 is a schematic diagram illustrating an embodiment of a stock allocation interface 500. Stock allocation interface 500 is used by a financial institution employee at a central processing location to add or remove stock to identified order-processing drawers. The order-processing drawers are used by retail branch operators to replenish negotiable items in customer service drawers. In the illustrated embodiment, stock allocation interface 500 is a GUI arranged to enable an authorized operator to allocate negotiable items to one or more order-processing drawers. Retail branch operators use the order-processing drawers to add or remove stock to identified customer service representative drawers. Negotiable items being issued to customers are processed from the customer service representative drawers.

Stock allocation interface 500 includes title bar 510, labeled “Stock allocation/Order Processing” that contains window controls to minimize, restore, or close the interface. Stock allocation interface 500 further includes control bar 520, which comprises a number of icon labeled pushbuttons that direct a common function to be applied to the stock allocation interface 500.

Stock allocation interface 500 includes select item 530, which when activated indicates that stock is being added and select item 532, which when activated indicates that stock is being removed. Stock allocation interface 500 further includes item type field 540 and issuer field 544 as well as article field 560, start serial number field 562, end serial number field 564, rate field 566, amount field 568 and total field 570. Pushbutton 542 enables a drop-down menu of additional selectable negotiable item types. Pushbutton 546 enables a drop-down menu of additional selectable issuer named types. Item type field 540 includes information regarding the negotiable item to be managed. Issuer field 544 includes an issuer's name for the negotiable item. Article field 560 includes information identifying a select article. Start serial number field 562 includes information responsive to an issuer's serial number on a first occurrence of the select article. End serial number 564 includes information responsive to an issuer's serial number on the last occurrence of the select article to be transferred into or out of the inventory. Rate field 566 includes information identifying the purchase/sell rate associated with each occurrence of the article. Amount field 568 includes information responsive to a line item total or a subtotal of the value associated with the order. Total field 570 includes information responsive to an amount associated with the entire order.

Stock allocation interface 500 also includes pushbutton 534, which when activated directs the enterprise server to add or remove the select negotiable items to the present inventory and pushbutton 536, which when activated clears operator entered data from the interface. Stock allocation interface 500 also presents data table 550, which includes title row 552. In the illustrated embodiment, title row 552 includes six columns labeled “article,” “start serial number,” “end serial number,” “count,” “rate,” and “amount.” Data table 550 further includes information stored within the enterprise database 115 in accordance with the displayed criteria. Moreover, stock allocation interface 500 may include additional pushbuttons, such as pushbutton 580 that when activated indicates that the operator acknowledges the select information and pushbutton 582 that cancels or otherwise closes stock allocation interface 500.

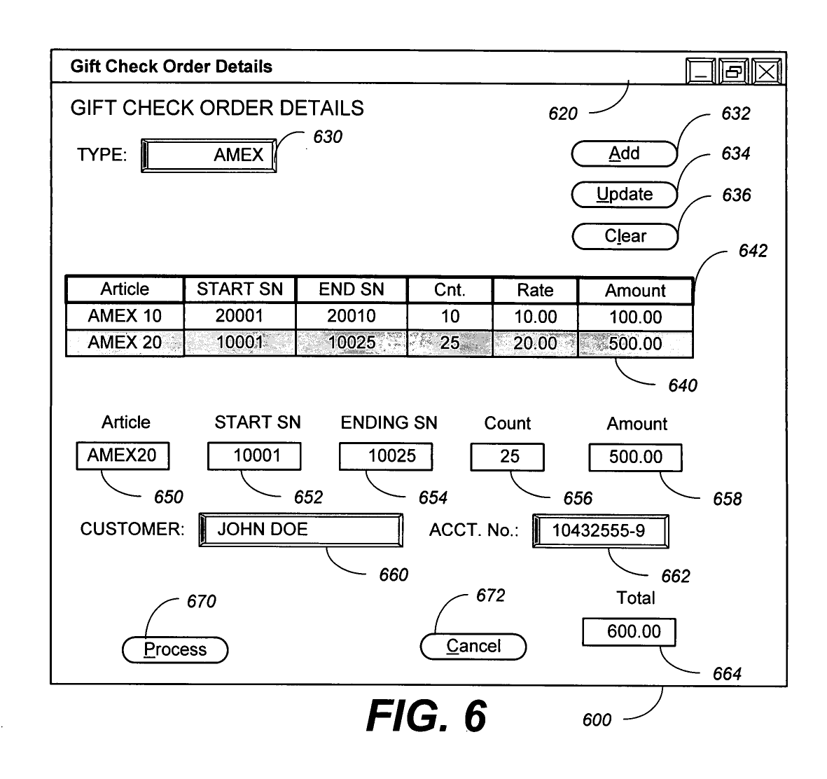

FIG. 6 is a schematic diagram illustrating an embodiment of a customer transaction interface 600. In the illustrated embodiment, the customer transaction interface 600 is a GUI arranged to enable a customer service representative to quickly fill a customer order for gift checks. Customer transaction interface 600 includes title bar 620, labeled “Gift Check Order Details” that contains window controls to minimize, restore, or close the interface. Customer transaction interface 600 further includes type field 630, customer field 660 and account field 662. Type field 630, customer field 660 and account field 662 are customer service representative adjustable. Type field 630 includes information regarding the negotiable item. Customer field 660 includes the name of the customer being served by the customer service representative. Account field 662 includes the customer's account number.

Customer transaction interface 600 also includes add pushbutton 632, update pushbutton 634, clear pushbutton 636, as well as process pushbutton 670, deny pushbutton 672, and cancel pushbutton 674. When activated, add pushbutton 632 directs drawer manager 227 (FIG. 2) to remove a select article and count from the drawer. Update pushbutton 634 is used in conjunction with inputs configured to receive an article identifier, a starting serial number and an ending serial number. When one of the inputs is changed, the update pushbutton 634 directs the customer transaction interface 600 to update various data fields in accordance with the change. When activated, clear pushbutton 636 will remove information presently stored in conjunction with the article, starting serial number and ending serial number.

Customer transaction interface 600 also includes data field 650, data field 652, data field 654, data field 656, data field 658 and data field 664. Data field 650 is configured to receive article identifiers. Data field 652 is configured to receive a start serial number, that is, the lowest serial number of a series of the select article that are to be transferred to the customer. Data field 654 is configured to receive an end serial number or the highest serial number of the select article that is to be transferred to the customer. Data field 656 provides a count and is automatically adjusted in accordance with the data in data field 652 and data field 654. When data field 656 is adjusted, the information in data field 654 is automatically adjusted. Data field 658 is configured to receive a subtotal of the dollar amount of gift cheeks to be sold to the customer. Data field 664 is configured to receive a total dollar amount of all gift checks to be sold to the customer. The information in data field 658 and data field 664 is automatically adjusted when the article and/or count is changed.

A summary of the gift check transaction is presented in data table 640, which includes title row 642. In the illustrated embodiment, title row 642 includes six columns labeled “article,” “start serial number,” “end serial number,” “count,” “rate,” and “amount.” Data table 640 further includes information stored within the enterprise database in accordance with the displayed criteria. This information is customer service representative selectable on a row by row or article by article basis. For example, when the second of the two rows displayed (of data table 640) is selected, corresponding data entry fields are populated for confirmation or adjustment by the customer service representative.

Moreover, customer transaction interface 600 includes pushbutton 670, labeled “process,” which when activated completes the purchase transaction in accordance with the present condition of the information displayed in the customer transaction interface 600 and pushbutton 762, labeled “cancel,” which closes customer transaction interface 600.

In operation, a customer service representative may fill a particular article with different blocks of serial numbers. In that case, the customer service representative needs to select the article of interest from the list, enters a start serial number and an end serial number and selects update pushbutton 634. If additional gift checks are desired in another denomination, the customer service representative enters the desired article and a different set of start and end serial numbers and selects add pushbutton 632. When the customer service representative activates pushbutton 670, the article count is checked against the requested count. When the counts match, the order is completed. When the counts do not match, the order is canceled. A canceled order will result in a warning message (not shown).

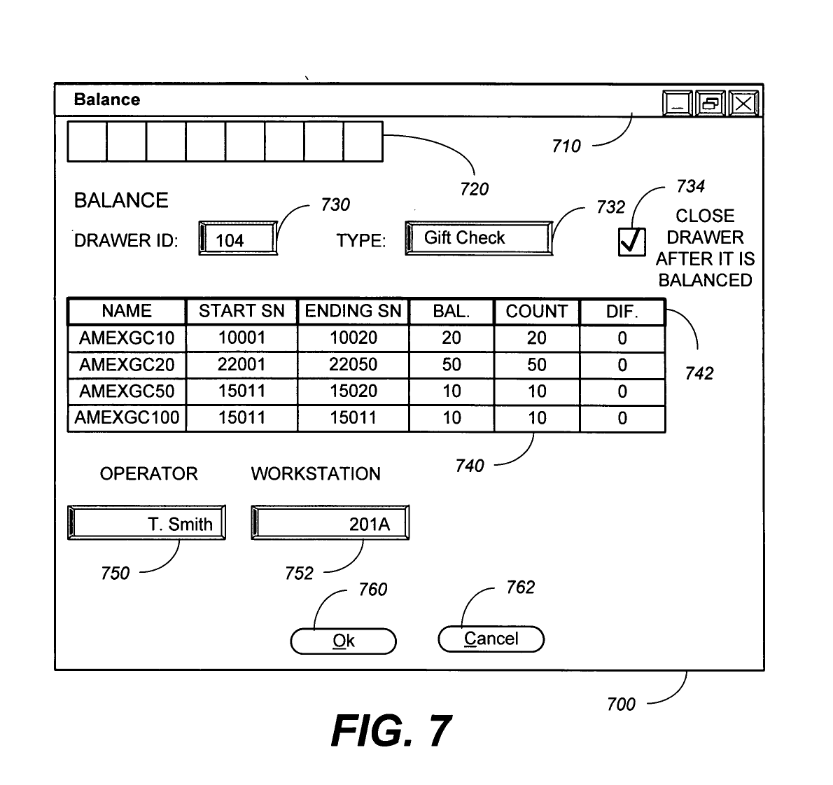

FIG. 7 is a schematic diagram illustrating an embodiment of a balance interface 700. In the illustrated embodiment, balance interface 700 is a GUI arranged to enable a customer service representative to quickly check the status of a select drawer in the enterprise database. Customer service representatives use the balance interface 700 to assist them in determining whether a particular drawer is in balance, that is, all negotiable items allocated to the drawer can be traced to a particular transaction. Essentially, balance interface 700 provides a count of the negotiable items in a select drawer. Balance interface 700 includes title bar 710, labeled “Balance” that contains window controls to minimize, restore, or close the interface. Balance interface 700 further includes control bar 720, which comprises a number of icon labeled pushbuttons that direct a common function to be applied to the balance interface 700. Balance interface 700 further includes drawer identification field 730, type field 732, operator field 750 and workstation field 752. Drawer identification field 730 includes information concerning a select drawer or placeholder. Type field 732 includes information regarding the negotiable item. Operator field 750 includes the name of an operator or customer service representative. Workstation field 752 includes information identifying a particular workstation within the enterprise. Checkbox 734 is an input that directs balance interface 700 to close the select drawer once the drawer is “balanced.”

Balance interface 700 also presents data table 740, which includes title row 742. In the illustrated embodiment, title row 742 includes six columns labeled “article,” “starting serial number,” “ending serial number,” “balance,” “count” and “difference.” Data table 740 further includes information stored within the enterprise database in accordance with the displayed criteria. Moreover, balance interface 700 includes pushbutton 760, which when activated indicates that the customer service representative acknowledges that the select drawer is “balanced” and pushbutton 762, which cancels or otherwise closes the balance interface 700.

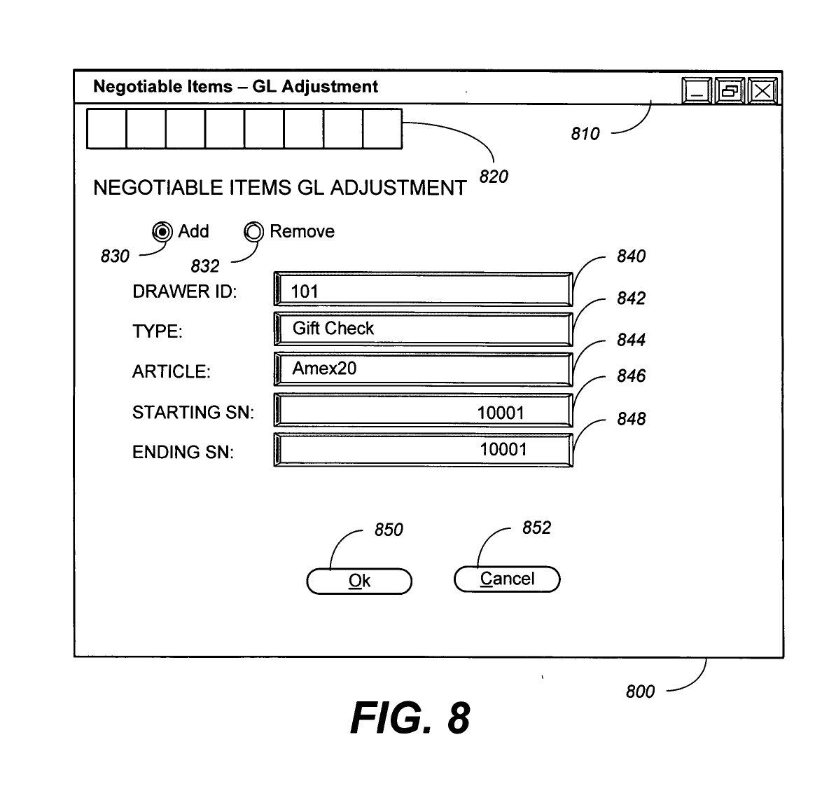

FIG. 8 is a schematic diagram illustrating an embodiment of a negotiable items adjustment interface 800. In the illustrated embodiment, adjustment interface 800 is a GUI arranged to enable a customer service representative to add or remove negotiable items from a select drawer in the enterprise database. Customer service representatives use the adjustment interface 800 to help balance the drawer by adding or removing items from the drawer inventory. Adjustment interface 800 includes title bar 810, labeled “Negotiable Items—GL Adjustment” that contains window controls to minimize, restore, or close the interface. Adjustment interface 800 further includes control bar 820, which comprises a number of icon labeled pushbuttons that direct a common function to be applied to the adjustment interface 800. Adjustment interface 800 also includes indicator 830, which when activated will direct adjustment interface 800 to add a negotiable item to the inventory of a specified drawer and indicator 832, which when activated will direct adjustment interface 800 to remove a negotiable item from the inventory. Adjustment interface 800 further includes drawer identification field 840, type field 842, article field 844, starting serial number field 846 and ending serial number field 848 each with a respective data item. Drawer identification field 840 includes information concerning a select drawer or placeholder. Type field 842 includes information regarding the negotiable item. Article field 844 includes an identifier or code that associates a denomination with the type of negotiable item. Starting serial number field 846 includes the number of the lowest serial number to be adjusted. Ending serial number field 848 includes the number of the highest serial number to be adjusted. Moreover, adjustment interface 800 includes pushbutton 850, which when activated initiates the directed adjustment and pushbutton 852, which cancels or otherwise closes the adjustment transaction without committing a change to the database information.

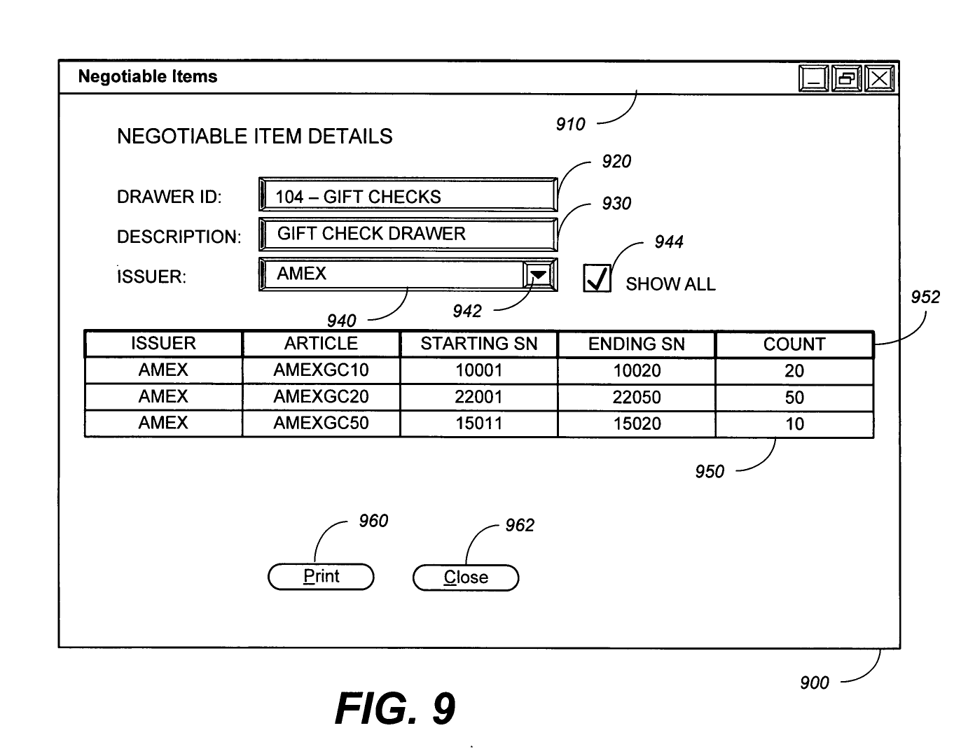

FIG. 9 is a schematic diagram illustrating an embodiment of a report interface 900. In the illustrated embodiment, report interface 900 is a GUI arranged to expose negotiable item details associated with select drawers in the enterprise database. In this regard, report interface 900 provides an inventory of the negotiable items in the customer service data base from which the items are allocated and issued. Unused items in the respective drawers are each drawer's inventory. Report interface 900 provides the system with search and print capabilities. Report interface 900 includes title bar 910, labeled “Negotiable Items” that contains window controls to minimize, restore, or close the interface. Report interface 900 also includes drawer identification field 920, description field 930, and issuer field 940 each with a respective data item. Drawer identification field 920 includes information concerning a select drawer or placeholder. Description field 930 includes information that reflects what negotiable items are displayed in the report interface 900. Issuer field 940 includes the name of a supplier of negotiable items. Pushbutton 942, labeled with an arrowhead icon, is an input that initiates a pull-down menu consisting of names of one or more other issuers of negotiable items. Checkbox 944 is an input that directs report interface 900 to display all denominations of negotiable items in the inventory of the select drawer (i.e., drawer 104—gift checks) from a select issuer. Data table 950 includes title row 952, which in the illustrated embodiment includes five columns labeled “issuer,” “article,” “starting serial number,” “ending serial number,” “and “count.” Data table 950 further includes information stored within the enterprise database in accordance with the displayed criteria. Pushbutton 960 is associated with a print command that generates a hard copy of the information presently displayed in report interface 900. Pushbutton 962 is an input item that directs the report interface 900 to close.

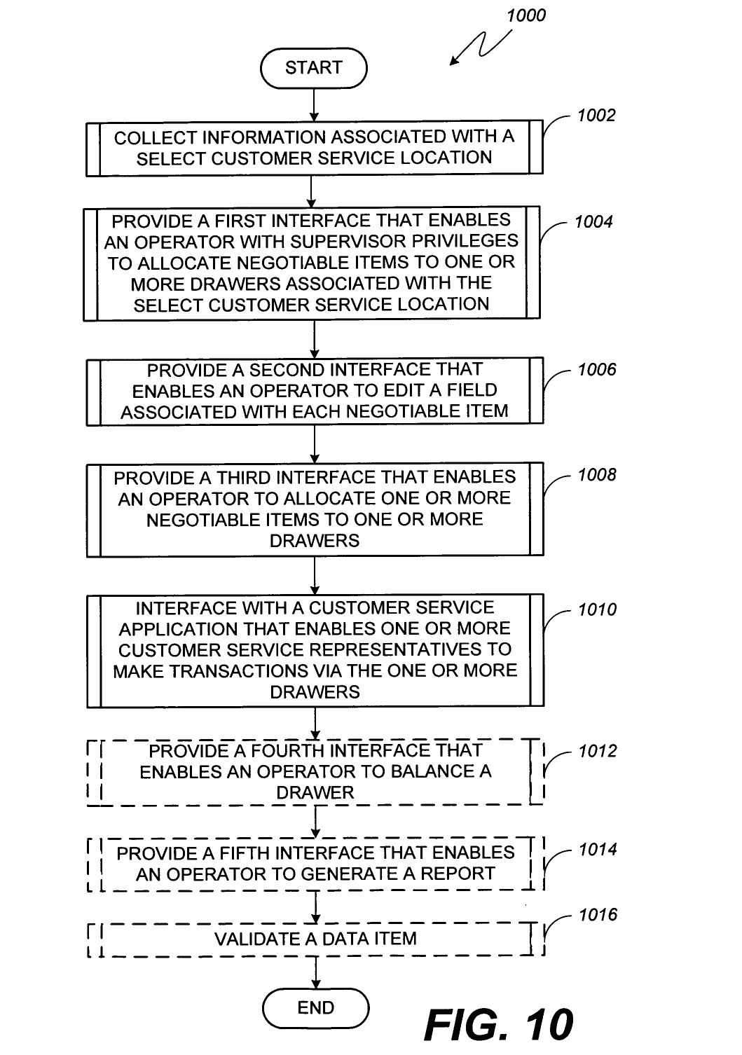

FIG. 10 is a flow diagram illustrating an embodiment of a method for managing an inventory of negotiable instruments. Method 1000 begins with block 1002 where information associated with a select customer service location is collected. In block 1004, a first interface is provided. The first interface enables an operator with supervisor privileges to allocate negotiable items to one or more drawers or placeholders associated with the select customer service location. In block 1006, a second interface is provided. The second interface enables an operator to edit information in a field associated with each negotiable item. In block 1008, a third interface is provided. The third interface enables an operator to allocate one or more negotiable items to one or more drawers. Thereafter, as indicated in block 1010 a customer service application is used to enable one or more customer service representatives to make transactions via the one or more drawers.

The flow diagram of FIG. 10 also includes a number of optional blocks. For example, in block 1012, a fourth interface is provided. The fourth interface enables an operator to balance a drawer. In block 1014, a fifth interface is provided. The fifth interface enables an operator to generate a report. In block 1016, a data item is validated. As described above, data validation includes checking entered information against one or more rules. The one or more rules vary in accordance with the type of information being validated. For example, an entered currency amount can be checked against a customer balance and against one or more format conditions to ensure that accurate data values are being entered into the system. By way of further example, an account number may be checked against one or more format conditions including one or more internal codes, such as a geographic indicator, a branch indicator, and an account type indicator.

Any process descriptions or blocks in the flowchart of FIG. 10 should be understood as representing modules, segments, or portions of code which include one or more executable instructions for implementing specific logical functions or steps in the method for managing an inventory of negotiable instruments. Alternate implementations are within the scope of the enterprise server system in which functions may be executed out of order from that shown or discussed, including substantially concurrently or in reverse order, and/or manually, depending on the functionality involved, as would be understood by those reasonably skilled in the art.

The systems and methods for managing an inventory of negotiable instruments are defined by the appended claims. The foregoing description has been presented for purposes of illustration and description to enable one of ordinary skill to make and use the systems and methods for managing an inventory of negotiable instruments. The foregoing description is not intended to be exhaustive or to limit the scope of the claims to the precise forms disclosed. Rather, a person skilled in the art will construe the appended claims broadly, to include other variants and embodiments of the invention, which those skilled in the art may make or use without departing from the claimed systems and methods and their equivalents.

What is claimed is:

1. A method for managing an inventory of negotiable instruments, comprising:
collecting information associated with a select location;
providing a first interface configured to enable an operator with supervisor privileges to allocate one or more negotiable items to one or more drawers associated with the select location;
providing a second interface configured to enable an operator with administrator privileges to edit a field associated with each negotiable item type;
providing a third interface configured to enable a customer service representative to allocate one or more negotiable items to the one or more drawers; and
interfacing with a customer service application that enables one or more customer service representatives to conduct transactions via the one or more drawers.

2. The method of claim 1, further comprising:
providing a fourth interface configured to enable one or more customer service representatives to balance a select drawer.

3. The method of claim 2, further comprising:
enabling one or more customer service representatives to remove an item from the select drawer.

4. The method of claim 1, further comprising:
providing a fifth interface configured to enable one or more operators to generate a report.

5. The method of claim 4, wherein the report is displayed.

6. The method of claim 4, wherein the report is printed.

7. The method of claim 1, further comprising:
validating a data item.

8. A system for managing negotiable items across an enterprise, the system comprising:
an enterprise server;
a data network coupled to the enterprise server;
a database coupled to the enterprise server via the data network; and
a network interface configured to couple one or more co-located customer service terminals to the enterprise server via the data network; wherein the enterprise server comprises logic that when executed is configured to create and maintain a menu driven interface exposing one or more drawers for holding a negotiable item that is shareable across the one or more co-located customer service terminals.

9. The system of claim 9, wherein the enterprise server comprises logic configured to create a drawer in response to a supervisor function.

10. The system of claim 9, wherein the enterprise server comprises logic configured to enable an action control selected from the group consisting of view, type, identifier, description, unit, and order.

11. The system of claim 9, wherein the enterprise server comprises logic configured to present information associated with a select drawer.

12. The system of claim 9, wherein the enterprise server comprises logic configured to assign an issuer to a negotiable item.

13. The system of claim 13, wherein the enterprise server comprises logic configured to assign a denomination to the negotiable item.

14. The system of claim 13, wherein the enterprise server comprises logic configured to assign a flag to the negotiable item.

15. The system of claim 15, wherein the flag is indicative of one or more of a permission, a fee, a conversion rate, an amount limit and a transaction limit.

16. The system of claim 9, wherein the enterprise server comprises logic configured to allocate negotiable items to a select drawer.

17. The system of claim 9, wherein the enterprise server comprises logic configured to de-allocate negotiable items from a select drawer.

18. The system of claim 9, wherein the enterprise server comprises logic configured to present balance information.

19. The system of claim 9, wherein the enterprise server comprises logic configured to enable an operator of a select customer service terminal to enter an adjustment request to a general ledger.

20. The system of claim 9, wherein the enterprise server comprises logic configured to validate one or more items associated with a sale transaction.
